(19) United States
(12) Patent Application Publication
(10) Pub. No.: US 2014/0114653 A1
(43) Pub. Date: Apr. 24, 2014

(54) PITCH ESTIMATOR

(71) Applicant: Nokia Corporation, Espoo (FI)

(72) Inventors: Lasse Juhani Laaksonen, Nokia (FI); Anssi Sakari Rämö, Tampere (FI); Adriana Vasilache, Tampere (FI); Mikko Tapio Tammi, Tampere (FI)

(73) Assignee: Nokia Corporation, Espoo (FI)

(21) Appl. No.: 14/115,498

(22) PCT Filed: May 6, 2011
(86) PCT No.: PCT/IB2011/052012

§ 371 Date: Nov. 4, 2013

(51) Int. Cl. G10L 25/90; G10L 25/93

(52) U.S. Cl. CPC G10L 25/90; G10L 25/93
USPC 704/208

(57) ABSTRACT

An apparatus comprising an analysis window definer configured to define at least one analysis window for a first audio signal, wherein the at least one analysis window definer is configured to be dependent on the first audio signal and a pitch estimator configured to determine a first pitch estimate for the first audio signal, wherein the pitch estimator is dependent on the first audio signal sample values within the analysis window.

### FIELD OF THE APPLICATION

The present application relates to a pitch estimator, and in particular, but not exclusively to a pitch estimator for use in speech or audio coding.

### BACKGROUND OF THE APPLICATION

Audio signals, like speech or music, are encoded for example to enable efficient transmission or storage of the audio signals.

Audio encoders and decoders (also known as codecs) are used to represent audio based signals, such as music and ambient sounds (which in speech coding terms can be called background noise). These types of coders typically do not utilise a speech model for the coding process, rather they use processes for representing all types of audio signals, including speech. Speech encoders and decoders (codecs) can be considered to be audio codecs which are optimised for speech signals, and can operate at either a fixed or variable bit rate.

An audio codec can also be configured to operate with varying bit rates. At lower bit rates, such an audio codec may work with speech signals at a coding rate equivalent to a pure speech codec. At higher bit rates, the audio codec may code any signal including music, background noise and speech, with higher quality and performance.

Pitch (also known as fundamental frequency of speech) is typically one of the key parameters in audio or speech coding and processing. The reliability of pitch estimation or pitch detection can be a decisive factor in the output quality of the overall system. Pitch estimation quality or confidence is especially important in the context of low bit rate speech coding based on the code excited linear prediction (CELP) principle where the pitch estimate, or adaptive codebook lag, is one of the key parameters of the encoding and any significant error in the pitch estimate is noticeable in the decoded speech signal. Pitch estimation or detection is also used typically in speech enhancement, automatic speech recognition and understanding as well analysis modelling of prosody (the rhythm, stress and intonation of speech). The algorithms used in these applications can be different, although generally one algorithm can be adapted to all applications.

For conversational speech coding, the complexity and delay requirements of the coding and decoding (codec) operation are typically strict. In other words the delay time of encoding and decoding of the audio have to be strictly enforced, otherwise the user can experience a real time delay causing awkward or unnatural conversations. This strict enforcement of delay time and complexity requirements are especially the case for new speech and audio coding solutions for the next generation of telecommunication systems currently referred to as enhanced voice service (EVS) codecs for evolved packet system (EPS) or long term evolution (LTE) telecommunication systems.

The EVS codec is envisaged to provide several different levels of quality. These levels of quality include considerations such as bit rate, algorithmic delay, audio bandwidth, number of channels, interoperability with existing standards and other considerations. Of particular interest are the low bit rate wideband (WB) with 7 kHz bandwidth coding as well as low bit rate super wideband (SWB) operating with a 14 or 16 kHz bandwidth coding. Both of these coding systems are expected to have interoperable and non-interoperable options with respect to 3^{rd} Generation Partnership Project Adaptive Multi-Rate Wideband (3GPP AMR-WB) standard.

The AMR-WB codec implements an algorithmic code excited linear prediction (ACELP) algorithm. Such CELP-based speech coders commonly carry out pitch detection or estimation in two steps. Firstly an open-loop analysis is performed on the audio or speech signals to determine a region of correct pitch and then a closed-loop analysis is used to select the optimal adaptive codebook index around the open-loop estimate.

Accurate pitch estimation or detection is typically challenging and there has been much research into this area. A particularly strong algorithm is the time-domain pitch estimation used in International Telecommunications Union (ITU-T) G.718 Speech and Audio Coding Standard. The G.718 speech coding standard pitch estimator uses a relaxed constraint for algorithmic delay, and it is believed that the 3GPP EVS Speech Coding Standard will have a much stricter delay and complexity requirements than ITU-T G.718.

### SUMMARY OF THE APPLICATION

Embodiments of the present application attempt to address the above problem.

There is provided according to a first aspect a method comprising: defining at least one analysis window for a first audio signal, wherein the at least one analysis window is dependent on the first audio signal; and determining a first pitch estimate for the first audio signal, wherein the first pitch estimate is dependent on the first audio signal sample values within the analysis window.

Defining the at least one analysis window may comprise defining at least one of: number of analysis windows; position of analysis window for each analysis window with respect to the first audio signal; and length of each analysis window.

The first audio signal may be divided into at least two portions.

The at least two portions may comprise: a first half frame portion; a second half frame portion succeeding the first half frame; and a look ahead frame portion succeeding the second half frame.

Defining the at least one analysis window may be dependent on the first audio signal comprises defining the analysis window dependent on: a position of the audio signal portion; a size of the audio signal portion; a size of neighbouring audio signal portions; a defined neighbouring audio signal portion analysis window; and at least one characteristic of the first audio signal.

The method may further comprise determining at least one characteristic of the first audio signal, wherein the first audio signal characteristic comprises at least one of: voiced audio; unvoiced audio; voiced onset audio; and voiced offset audio.

Defining at least one analysis window for a first audio signal may be dependent on a defined structure of the first audio signal and performed prior to receiving the first audio signal sample values.

Defining the at least one analysis window may comprise: defining at least one window in at least one of the portions; and defining at least one further window in at least one further portion dependent on the at least one window.

The determination of the at least one analysis window may be further dependent on the processing capacity of the pitch estimator.

Determining the first pitch estimate for the first audio signal may comprise determining an autocorrelation value for each analysis window.

Determining the first pitch estimate may comprise tracking the autocorrelation values for each analysis window over the length of the first audio signal.

Determining the first pitch estimate may be dependent on at least one characteristic of the first audio signal.

The at least one characteristic of the audio signal may comprise determining the at least one audio signal is over at least two portions of the audio signal a voiced onset audio signal then wherein determining the first pitch estimate comprises reinforcing the pitch estimate value in a second portion of the audio signal over the pitch estimate value in a first portion of the audio signal preceding the second portion of the audio signal; voiced and/or voiced offset audio signal then determining the first pitch estimate comprises reinforcing the pitch estimate value in the first portion of the audio signal over the pitch estimate value in a second portion of the audio signal succeeding the first portion of the audio signal; and unvoiced speech or no-speech then modifying a reinforcing function to be applied to the pitch estimation value.

According to a second aspect there is provided an apparatus comprising at least one processor and at least one memory including computer program code for one or more programs, the at least one memory and the computer program code configured to, with the at least one processor, cause the apparatus at least to perform: defining at least one analysis window for a first audio signal, wherein the at least one analysis window is dependent on the first audio signal; and determining a first pitch estimate for the first audio signal, wherein the first pitch estimate is dependent on the first audio signal sample values within the analysis window.

Defining the at least one analysis window may cause the apparatus to further perform defining at least one of: number of analysis windows; position of analysis window for each analysis window with respect to the first audio signal; and length of each analysis window.

The first audio signal may be divided into at least two portions.

The at least two portions may comprise: a first half frame portion; a second half frame portion succeeding the first half frame; and a look ahead frame portion succeeding the second half frame.

Defining the at least one analysis window is dependent on the first audio signal may cause the apparatus to further perform defining the analysis window dependent on at least one of: a position of the audio signal portion; a size of the audio signal portion; a size of neighbouring audio signal portions; a defined neighbouring audio signal portion analysis window; and at least one characteristic of the first audio signal.

The apparatus may further be caused to perform determining at least one characteristic of the first audio signal, wherein the first audio signal characteristic may comprise at least one of: voiced audio; unvoiced audio; voiced onset audio; and voiced offset audio.

Defining at least one analysis window for a first audio signal may be dependent on a defined structure of the first audio signal and performed prior to receiving the first audio signal sample values.

Defining the at least one analysis window may cause the apparatus to further perform: defining at least one window in at least one of the portions; and defining at least one further window in at least one further portion dependent on the at least one window.

Determination of the at least one analysis window may be further dependent on the processing capacity of the pitch estimator.

Determining the first pitch estimate for the first audio signal may further cause the apparatus to perform determining an autocorrelation value for each analysis window.

Determining the first pitch estimate may cause the apparatus to further perform tracking the autocorrelation values for each analysis window over the length of the first audio signal.

Determining the first pitch estimate may be dependent on at least one characteristic of the first audio signal.

The apparatus may be further caused to perform determining the at least one characteristic of the audio signal over at least two portions of the audio signal and wherein determining: a voiced onset audio signal may further cause determining the first pitch estimate to perform reinforcing the pitch estimate value in a second portion of the audio signal over the pitch estimate value in a first portion of the audio signal preceding the second portion of the audio signal; a voiced and/or voiced offset audio signal may further cause determining the first pitch estimate to perform reinforcing the pitch estimate value in the first portion of the audio signal over the pitch estimate value in a second portion of the audio signal succeeding the first portion of the audio signal; and an unvoiced speech or no-speech audio signal may further cause determining the first pitch estimate to perform modifying a reinforcing function to be applied to the pitch estimation value.

According to a third aspect there is provided an apparatus comprising: means for defining at least one analysis window for a first audio signal, wherein the at least one analysis window is dependent on the first audio signal; and means for determining a first pitch estimate for the first audio signal, wherein the first pitch estimate is dependent on the first audio signal sample values within the analysis window.

The means for defining the at least one analysis window may comprise means for defining at least one of: number of analysis windows; position of analysis window for each analysis window with respect to the first audio signal; and length of each analysis window.

The first audio signal may be divided into at least two portions.

The at least two portions may comprise: a first half frame portion; a second half frame portion succeeding the first half frame; and a look ahead frame portion succeeding the second half frame.

The means for defining the at least one analysis window may comprise means for defining the analysis window dependent on at least one of: a position of the audio signal portion; a size of the audio signal portion; a size of neighbouring audio signal portions; a defined neighbouring audio signal portion analysis window; and at least one characteristic of the first audio signal.

The apparatus may further comprise means for determining at least one characteristic of the first audio signal, wherein the first audio signal characteristic may comprise at least one of: voiced audio; unvoiced audio; voiced onset audio; and voiced offset audio.

The means for defining at least one analysis window for a first audio signal may be dependent on a defined structure of the first audio signal.

The means for defining the at least one analysis window may comprise: means for defining at least one window in at least one of the portions; and means for defining at least one further window in at least one further portion dependent on the at least one window.

The means for determining the at least one analysis window may be further dependent on the processing capacity of the pitch estimator.

The means for determining the first pitch estimate for the first audio signal may comprise means for determining an autocorrelation value for each analysis window.

The means for determining the first pitch estimate may comprise means for tracking the autocorrelation values for each analysis window over the length of the first audio signal.

The means for determining the first pitch estimate may be dependent on at least one characteristic of the first audio signal.

The apparatus may further comprise means for determining the at least one characteristic of the audio signal over at least two portions of the audio signal and wherein determining: a voiced onset audio signal, the means for determining at least one characteristic may further be configured to control the means for determining the first pitch estimate to reinforce the pitch estimate value in a second portion of the audio signal over the pitch estimate value in a first portion of the audio signal preceding the second portion of the audio signal; a voiced and/or voiced offset audio signal, the means for determining at least one characteristic may further be configured to control the means for determining the first pitch estimate to perform reinforcing the pitch estimate value in the first portion of the audio signal over the pitch estimate value in a second portion of the audio signal succeeding the first portion of the audio signal; and an unvoiced speech or no-speech audio signal, the means for determining at least one characteristic may further be configured to control the means for determining the first pitch estimate to perform modifying a reinforcing function to be applied to the pitch estimation value.

According to a fourth aspect there is provided an apparatus comprising: an analysis window definer configured to define at least one analysis window for a first audio signal, wherein the at least one analysis window definer is configured to be dependent on the first audio signal; and a pitch estimator configured to determine a first pitch estimate for the first audio signal, wherein the pitch estimator is dependent on the first audio signal sample values within the analysis window.

The analysis window definer may be configured to define at least one of: number of analysis windows; position of analysis window for each analysis window with respect to the first audio signal; and length of each analysis window.

The first audio signal may be divided into at least two portions.

The at least two portions may comprise: a first half frame portion; a second half frame portion succeeding the first half frame; and a look ahead frame portion succeeding the second half frame.

The analysis window definer may be configured to define the analysis window dependent on at least one of: a position of the audio signal portion; a size of the audio signal portion; a size of neighbouring audio signal portions; a defined neighbouring audio signal portion analysis window; and at least one characteristic of the first audio signal.

The apparatus may further comprise an audio signal categoriser configured to determine at least one characteristic of the first audio signal, wherein the first audio signal characteristic may comprise at least one of: voiced audio; unvoiced audio; voiced onset audio; and voiced offset audio.

The analysis window definer may be configured to be dependent on a defined structure of the first audio signal.

The analysis window definer may comprise: a first window definer configured to define at least one window in at least one of the portions; and a further window definer configured to define at least one further window in at least one further portion dependent on the at least one window.

The analysis window definer may be configured to be dependent on the processing capacity of the pitch estimator.

The pitch estimator may comprise an autocorrelator configured to determine an autocorrelation value for each analysis window.

The pitch estimator may further comprise a pitch tracker configured to track the autocorrelation values for each analysis window over the length of the first audio signal.

The pitch estimator may be configured to determine the first pitch estimate dependent on at least one characteristic of the first audio signal.

The apparatus may further comprise a signal analyser configured to determine the at least one characteristic of the audio signal over at least two portions of the audio signal and wherein the analyser may be configured to on determining: a voiced onset audio signal, control the pitch estimator to reinforce the pitch estimate value in a second portion of the audio signal over the pitch estimate value in a first portion of the audio signal preceding the second portion of the audio signal; a voiced and/or voiced offset audio signal, control the pitch estimator to reinforce the pitch estimate value in the first portion of the audio signal over the pitch estimate value in a second portion of the audio signal succeeding the first portion of the audio signal; and an unvoiced speech or no-speech audio signal, control the pitch estimator to modify a reinforcing function to be applied to the pitch estimation value.

A computer program product may cause an apparatus to perform the method as described herein.

An electronic device may comprise apparatus as described herein.

A chipset may comprise apparatus as described herein.

### BRIEF DESCRIPTION OF DRAWINGS

For better understanding of the present invention, reference will now be made by way of example to the accompanying drawings in which:

FIG. 1 shows schematically an electronic device employing some embodiments of the application;

FIG. 2 shows schematically an audio codec system employing a open loop pitch estimator according to some embodiments of the application;

FIG. 3 shows schematically a pitch estimator as shown in FIG. 2 according to some embodiments of the application;

FIGS. 4 to 6 shows schematically components of the pitch estimator as shown in FIG. 2 in further detail according to some embodiments of the application;

FIG. 7 shows a flow diagram illustrating the operation of the pitch estimator;

FIGS. 8 to 10 show further flow diagrams illustrating the operation of the pitch estimator in further detail; and

FIGS. 11 to 14 show schematically pitch estimation analysis windows according to some embodiments.

### DESCRIPTION OF SOME EMBODIMENTS OF THE APPLICATION

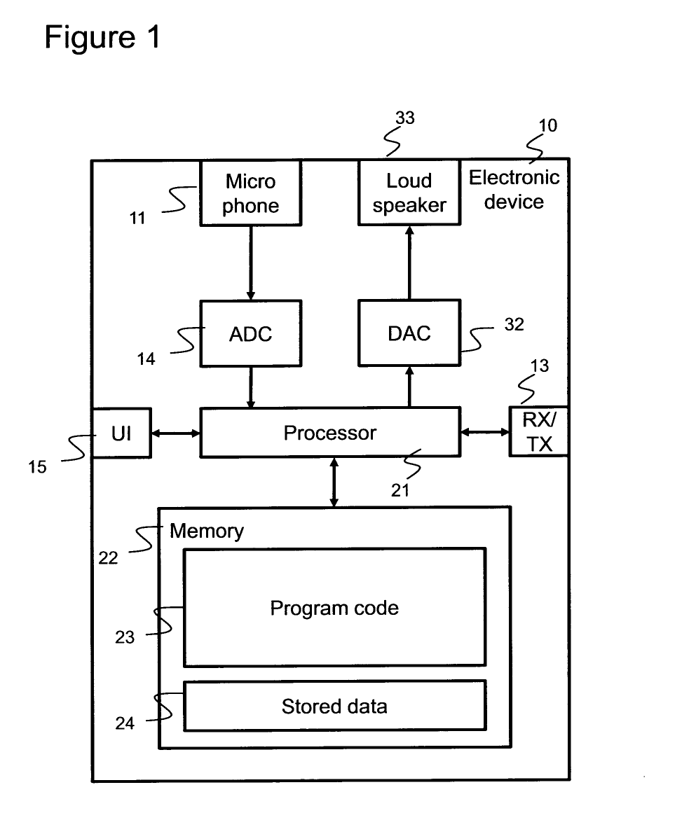

The following describes in more detail possible pitch estimation mechanisms for the provision of new speech and audio codecs, including layered or scalable variable rate speech and audio codecs. In this regard reference is first made to FIG. 1 which shows a schematic block diagram of an exemplary electronic device or apparatus 10, which may incorporate a codec according to an embodiment of the application.

The apparatus 10 may for example be a mobile terminal or user equipment of a wireless communication system. In other embodiments the apparatus 10 may be an audio-video device such as video camera, a Television (TV) receiver, audio recorder or audio player such as a mp3 recorder/player, a media recorder (also known as a mp4 recorder/player), or any computer suitable for the processing of audio signals.

The electronic device or apparatus 10 in some embodiments comprises a microphone 11, which is linked via an analogue-to-digital converter (ADC) 14 to a processor 21. The processor 21 is further linked via a digital-to-analogue (DAC) converter 32 to loudspeakers 33. The processor 21 is further linked to a transceiver (RX/TX) 13, to a user interface (UI) 15 and to a memory 22.

The processor 21 can in some embodiments be configured to execute various program codes. The implemented program codes in some embodiments comprise a pitch estimation code as described herein. The implemented program codes 23 can in some embodiments be stored for example in the memory 22 for retrieval by the processor 21 whenever needed. The memory 22 could further provide a section 24 for storing data, for example data that has been encoded in accordance with the application.

The encoding and decoding code in embodiments can be implemented in hardware and/or firmware.

The user interface 15 enables a user to input commands to the electronic device 10, for example via a keypad, and/or to obtain information from the electronic device 10, for example via a display. In some embodiments a touch screen may provide both input and output functions for the user interface. The apparatus 10 in some embodiments comprises a transceiver 13 suitable for enabling communication with other apparatus, for example via a wireless communication network.

It is to be understood again that the structure of the apparatus 10 could be supplemented and varied in many ways.

A user of the apparatus 10 for example can use the microphone 11 for inputting speech or other audio signals that are to be transmitted to some other apparatus or that are to be stored in the data section 24 of the memory 22. A corresponding application in some embodiments can be activated to this end by the user via the user interface 15. This application in these embodiments can be performed by the processor 21, causes the processor 21 to execute the encoding code stored in the memory 22.

The analogue-to-digital converter (ADC) 14 in some embodiments converts the input analogue audio signal into a digital audio signal and provides the digital audio signal to the processor 21. In some embodiments the microphone 11 can comprise an integrated microphone and ADC function and provide digital audio signals directly to the processor for processing.

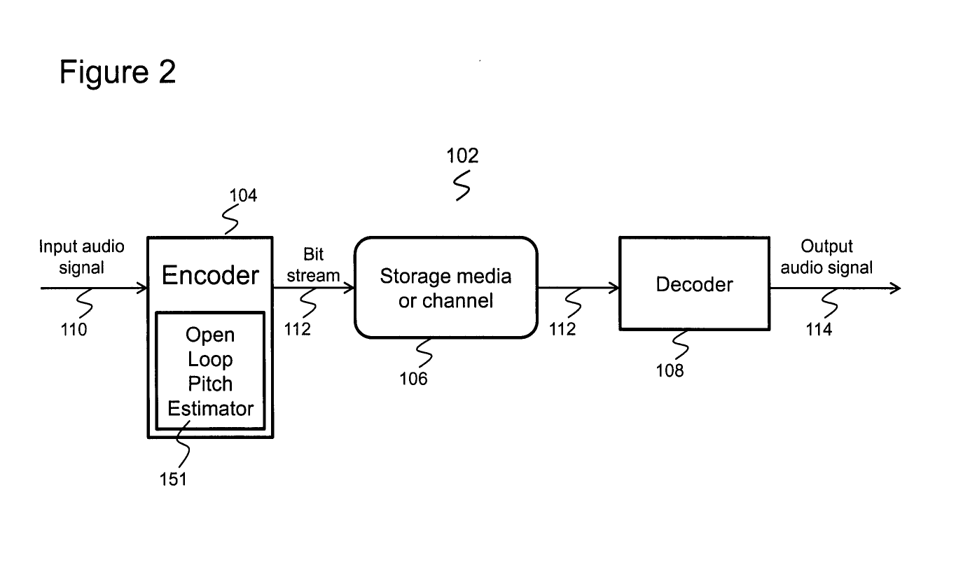

The processor 21 in such embodiments then processes the digital audio signal in the same way as described with reference to FIGS. 2 to 10.

The resulting bit stream can in some embodiments be provided to the transceiver 13 for transmission to another apparatus. Alternatively, the coded audio data in some embodiments can be stored in the data section 24 of the memory 22, for instance for a later transmission or for a later presentation by the same apparatus 10.

The apparatus 10 in some embodiments can also receive a bit stream with correspondingly encoded data from another apparatus via the transceiver 13. In this example, the processor 21 may execute the decoding program code stored in the memory 22. The processor 21 in such embodiments decodes the received data, and provides the decoded data to a digital-to-analogue converter 32. The digital-to-analogue converter 32 converts the digital decoded data into analogue audio data and can in some embodiments output the analogue audio via the loudspeakers 33. Execution of the decoding program code in some embodiments can be triggered as well by an application called by the user via the user interface 15.

The received encoded data in some embodiment can also be stored instead of an immediate presentation via the loudspeakers 33 in the data section 24 of the memory 22, for instance for later decoding and presentation or decoding and forwarding to still another apparatus.

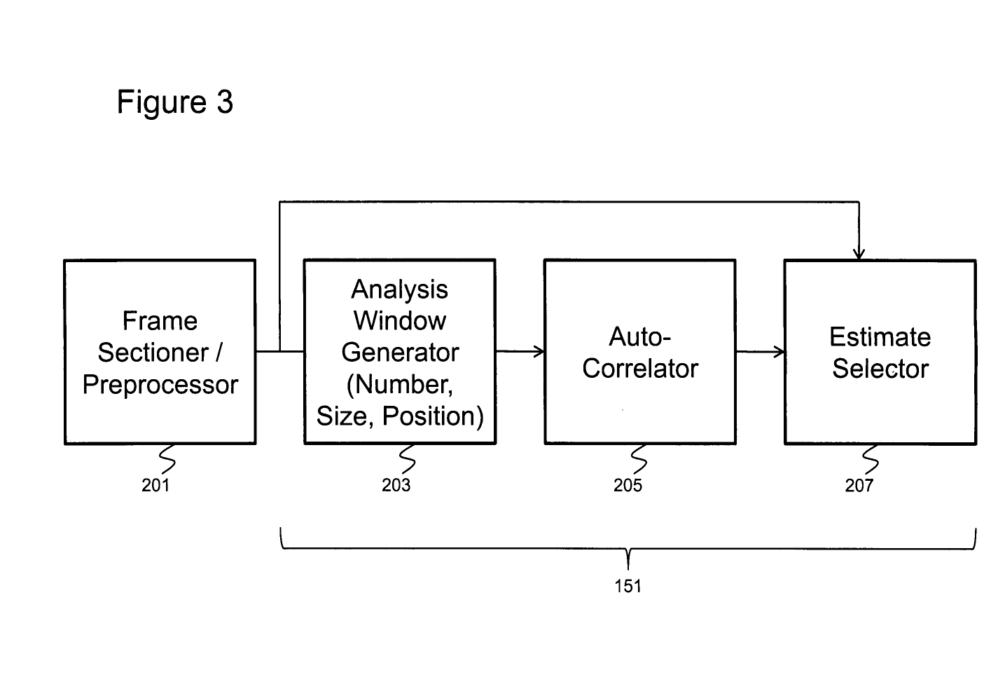

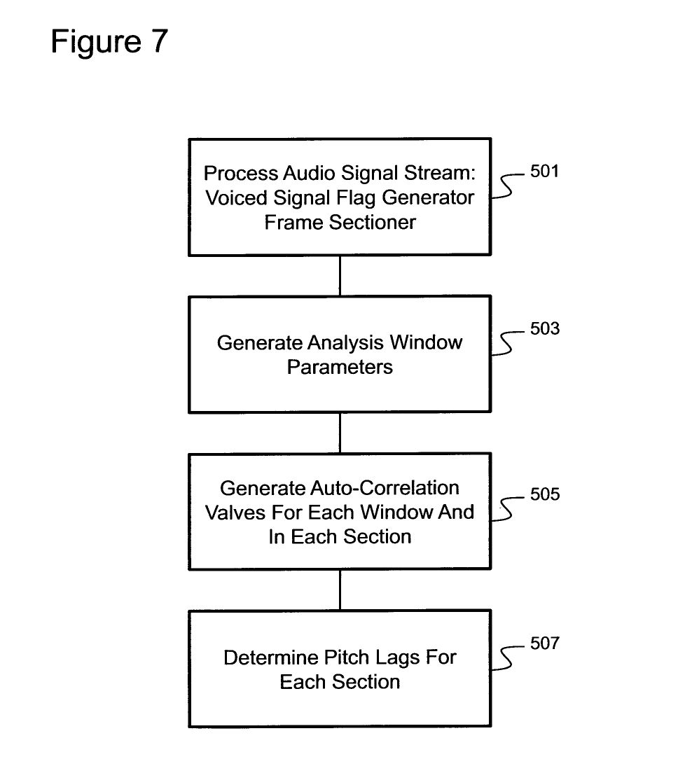

It would be appreciated that the schematic structures described in FIGS. 3 to 6, and the method steps shown in FIGS. 7 to 10 represent only a part of the operation of an audio codec and specifically part of a pitch estimation and/or tracking apparatus or method as exemplarily shown implemented in the electronic device shown in FIG. 1.

The general operation of audio codecs as employed by embodiments of the application is shown in FIG. 2. General audio coding/decoding systems comprise both an encoder and a decoder, as illustrated schematically in FIG. 2. However, it would be understood that embodiments of the application may implement one of either the encoder or decoder, or both the encoder and decoder. Illustrated by FIG. 2 is a system 102 with an encoder 104, a storage or media channel 106 and a decoder 108. It would be understood that as described above some embodiments of the apparatus 10 can comprise or implement one of the encoder 104 or decoder 108 or both the encoder 104 and decoder 108.

The encoder 104 compresses an input audio signal 110 producing a bit stream 112, which in some embodiments can be stored or transmitted through a media channel 106. The encoder 104 furthermore can comprise an open loop pitch estimator 151 as part of the overall encoding operation.

The bit stream 112 can be received within the decoder 108. The decoder 108 decompresses the bit stream 112 and produces an output audio signal 114. The bit rate of the bit stream 112 and the quality of the output audio signal 114 in relation to the input signal 110 are the main features which define the performance of the coding system 102.

FIG. 3 shows schematically a pitch estimator 151 according to some embodiments of the application.

FIG. 7 shows schematically in a flow diagram the operation of the pitch estimator 151 according to embodiments of the application.

The audio signal (or speech signal) can be received within the apparatus by a frame sectioner/preprocessor 201. The frame sectioner/preprocessor 201 can in some embodiments be configured to perform any suitable or required operations of preprocessing of the digital audio signal so that the signal can be coded. These preprocessing operations can in some embodiments be for example include sampling conversion, high pass filtering, spectral pre-emphasis according to the codec being employed, spectral analysis (which provides the energy per critical bands), voice activity detection (VAD), noise reduction, and linear prediction (LP) analysis (resulting in linear predictive (LP) synthesis filter coefficients). Furthermore in some embodiments a perceptual weighting can be performed by filtering the digital audio signal through a perceptual weighting filter derived from the linear predictive synthesis filter coefficient resulting in a weighted speech signal.

Furthermore in some embodiments the frame sectioner/preprocessor sections (or segments) the audio signal data into sections or frames suitable for processing by the pitch estimator 151. The pitch estimator 151 is typically configured to perform an open-loop pitch analysis on the audio signal such that it calculates one or more estimates of the pitch lag for each frame. For example three estimates can be determined such that there are generated one estimate for each half frame of the present frame and one estimate in the first half frame of the next frame (which can be used or known as a look-ahead frame).

In some embodiments the frame sectioner/preprocessor 201 can be configured to perform a signal source analysis on the audio signal. For example in some embodiments the signal source analysis can determine for a current frame and the following look-ahead frame section whether or not the speech signal is unvoiced, voiced, or experiencing voiced onset or voiced offset. In addition, the signal source analysis can in some embodiments provide an estimate of background noise level and other such characteristics. This source signal analysis can in some embodiments be passed directly to an estimate selector 207.

Furthermore the output of the frame sectioner 201 can in some embodiments be passed to an analysis window generator 203.

The operations of the preprocessor and the relative length of the frames and the frame sections can be any suitable length constrained by the delay budget. For example the pre-processor 201 of G.718 receives frames of 20 milliseconds and is configured to divide the current frame into two halves of each 10 milliseconds such that the frame sectioner and pre-processor outputs 10 millisecond sections to the analysis window generator 203 so that for each analysis the analysis window generator receives two 10 millisecond sections from the current frame and one 10 millisecond section from the look-ahead frame.

The operation of processing the audio signal stream and sectioning the frame is shown in FIG. 7 by step 501. In some embodiments the frame sectioner/preprocessor can be part of the open-loop pitch estimator 151 however in the following example the pitch estimator operations start on receiving the section data.

The pitch estimator 151 can in some embodiments comprise an analysis window generator 203. The analysis window generator 203 or means for defining at least one analysis window for a first audio signal is configured in some embodiments to generate for each of the half frame and look-ahead frame section analysis window identifiers such that defined parts of each section are analysed. The analysis window is a range of sample values over which the autocorrelator 205 can generate autocorrelation values for. The analysis window generator 203 is in such embodiments configured to generate for each of the half frame and look-ahead frame sections, a number of windows, size of windows, and position of windows which in some embodiments can be passed to the autocorrelator for generating the autocorrelation values. In other words in some embodiments the means for defining at least one analysis window comprises means for defining at least one of: number of analysis windows; position of analysis window for each analysis window with respect to the first audio signal; and length of each analysis window.

The operation of generating the analysis window parameters is shown in FIG. 7 by step 503.

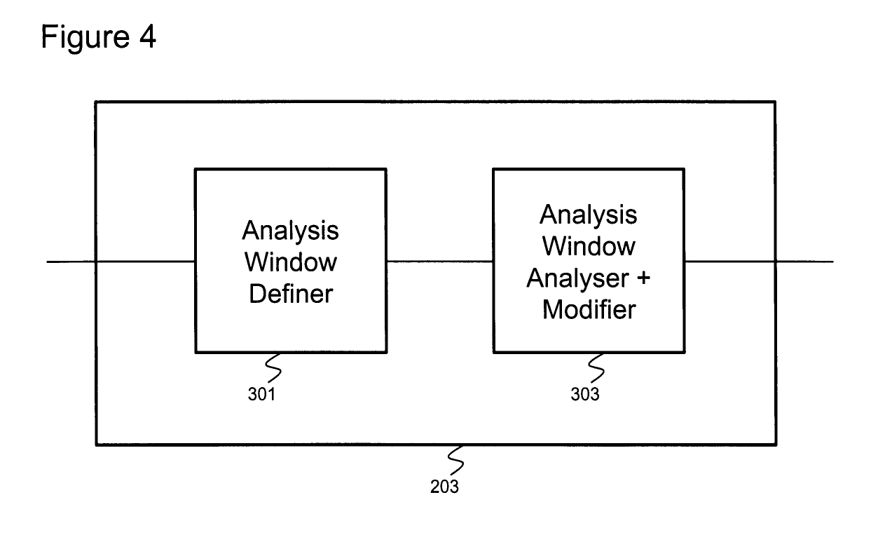

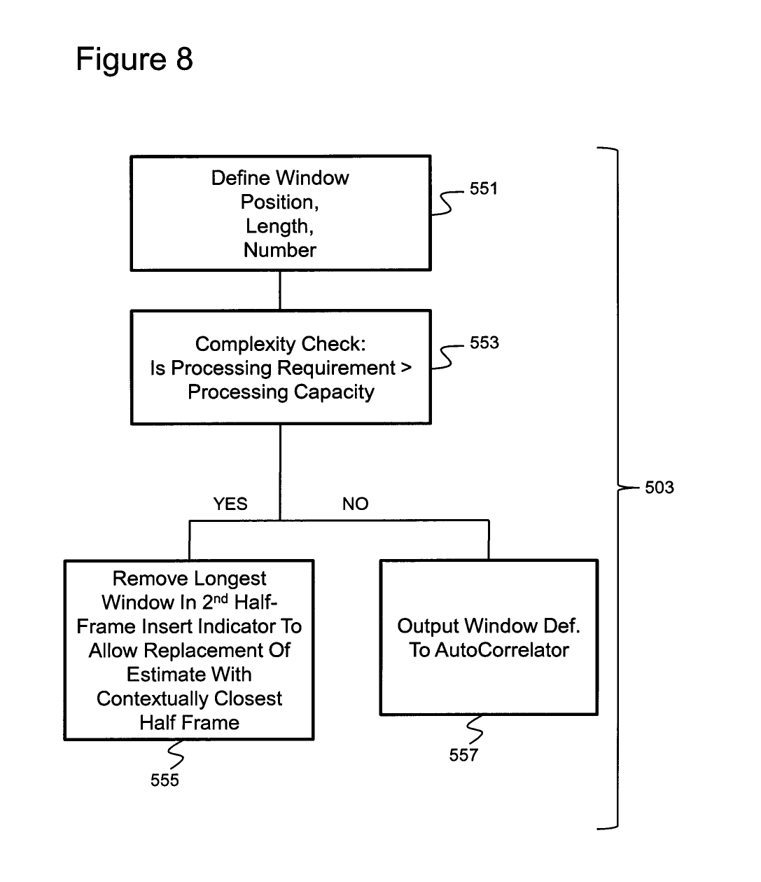

With respect to FIG. 4, the analysis window generator is shown in further detail. Furthermore with respect to FIG. 8, the analysis window generator operations are shown in further detail according to some embodiments of the application.

The analysis window generator in some embodiments comprises an analysis window definer 301. The analysis window definer is configured to define an initial series of analysis windows with respect to each of the half frame and look-ahead frame sections.

The operation of defining the windows in terms of position, length and number for each of the half sections of the frame and look-ahead segment is shown in FIG. 8 by step 551.

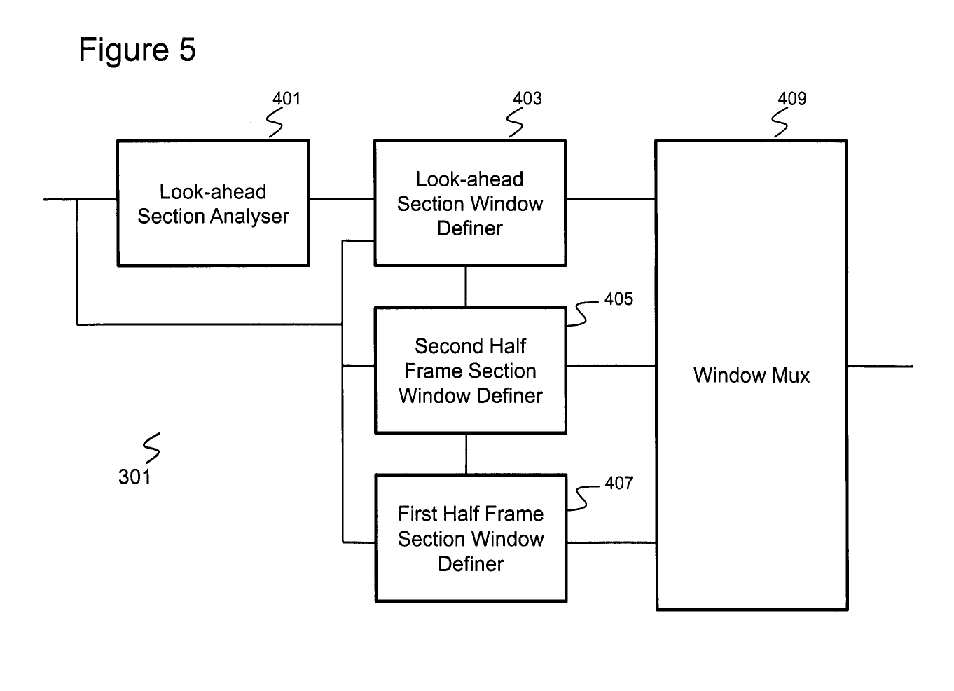

With respect to FIG. 5 the analysis window definer is shown in further detail.

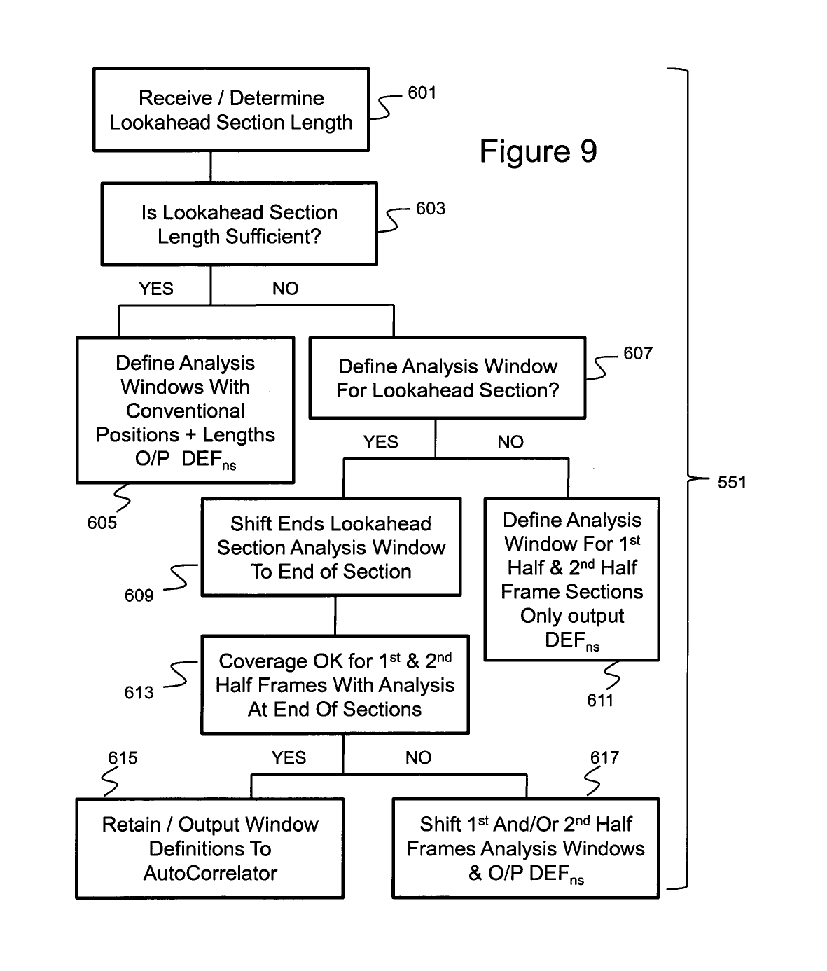

Furthermore with respect to FIG. 9 the operation of the analysis window definer in further detail is shown schematically by a flow diagram showing the operation of the analysis window definer according to some embodiments of the application.

In some embodiments of the application the analysis window definer 301 comprises a look-ahead section analyzer 401. The look-ahead section analyzer 401 is configured to determine from the look-ahead section data the length of the look-ahead section.

The operation of receiving or determining the look-ahead section length is shown in FIG. 9 by step 601.

The look-ahead section analyzer can in some embodiments furthermore perform a check operation to determine whether or not the look-ahead section length is “sufficient”.

The operation of checking whether or not the look-ahead section length is “sufficient” is shown in FIG. 9 by step 603.

In some embodiments the look-ahead section length is fixed or can vary from frame to frame depending upon whether the audio codec is operating with a variable delay operation or delay switching.

The look-ahead section analyser 401 can perform a sufficiency determination in some embodiments by checking the length of the look-ahead segment against a determined segment length threshold or thresholds. In some embodiments a look-ahead section threshold length can be determined as a value such that where the length of the look-ahead segment is less than or equal to the threshold length, the look-ahead section analyzer 401 determines that the look-ahead section length is “not sufficient” for the further processing operations, wherein the look-ahead section analyzer 401 can determine that where the look-ahead section length is greater than the threshold then the look-ahead section length is “sufficient”.

The threshold length determination can in some embodiments depend on a template for analysis window length. For example for a known window length a look-ahead section which is shorter than the window can lack enough information to produce a reliable or accurate pitch estimation and thus could be liable to generate error or erratic pitch estimations.

The operation of determining whether or not the look-ahead section length is “sufficient” is shown in FIG. 9 by step 603.

Where the look-ahead section length is determined to be sufficient, the look-ahead section analyzer 401 can further indicate or provide an indication to the look-ahead section window definer 403, and optionally in some embodiments to the second half frame section window definer 405 and first half frame section window definer 407 that a default window position and length and number is suitable.

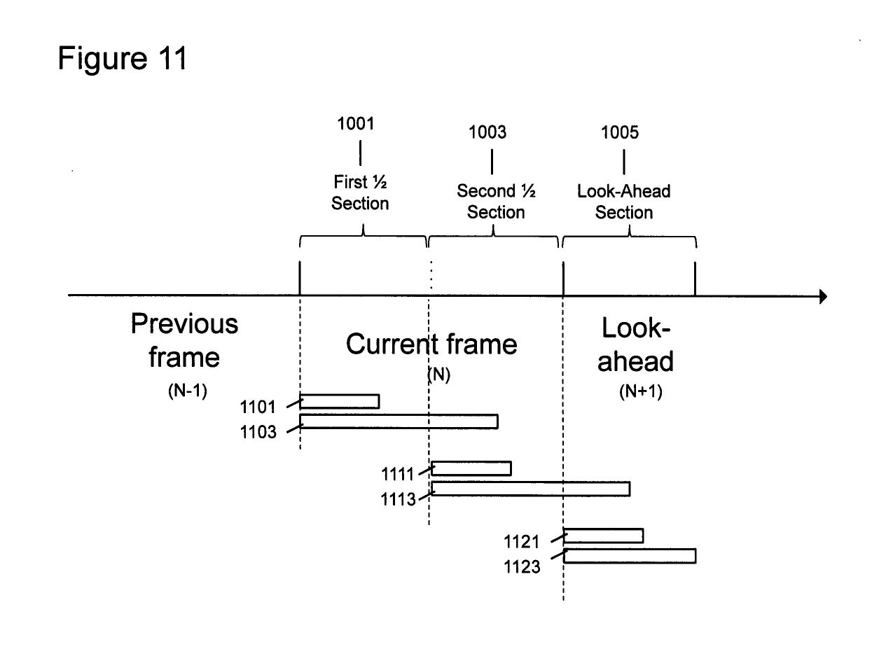

With respect to FIG. 11, an example of the default analysis windows with positions and lengths for the longest and shortest analysis windows are shown. In this example the previous frame, current frame, and look-ahead frames are shown wherein for the current frame the first half section 1001 and the second half section 1003 are followed by a look-ahead section 1005 of a “sufficiently” long length. In such an example arrangement of windows, the current frame first half section 1001 has a short analysis window 1101 which is defined as starting from the beginning of the first half section, and a long analysis window 1103 which also starts at the beginning of the first half section. The second half section 1003 has a short analysis window 1111 starting from the beginning of the second half section 1003, and a long analysis window 1113 also starting from the beginning of the second half section. Furthermore the look-ahead section 1005 has a short analysis window 1121 starting from the beginning of the look-ahead section 1005, and a long analysis window 1123 also starting from the beginning of the look-ahead section.

As can be seen from the example in FIG. 11, the longest window length can extend beyond the current section for the current frame half sections. Thus the longest window length for the first half section 1103 can extend into the second half section 1003, and the longest window length for the second half section 1113 can extend into the look-ahead section 1005. However, the longest window length for the look-ahead section 1123 cannot extend beyond the data of the look-ahead section (as no such data is available to us) and as such has a smaller analysis window length than the longest first half section and second half section window length 1103 and 1113 respectively.

The analysis window definer in some embodiments comprises a look-ahead section window definer 403. The look-ahead section window definer 403 can be configured in some embodiments to receive indications from the look-ahead section analyzer 401 and the segment information to define a number, and position, and length of analysed windows to be used in analysis with regards to the look-ahead section. Thus, for example as described herein, when the look-ahead section analyzer 401 is configured to indicate to the look-ahead section window definer 403 that the look-ahead section is sufficient then the look-ahead section window definer 403 can define a number of windows for analysis, aligned such that the analysis windows start from the beginning of the look-ahead section as shown in FIG. 11.

Furthermore with respect to FIG. 5 the analysis window definer 301 can in some embodiments comprise a second half frame section window definer 405. The second half frame section window definer 405 can in some embodiments receive both the section information with regards to the second half frame section and also in some embodiments information from the look-ahead section window definer 403 such as the look-ahead section window information and from this information define a series of second half frame section windows. Thus, for example as shown in FIG. 11, when receiving from the look-ahead section window definer 403 information or indications that the look-ahead section is a default look-ahead section window arrangement then the second half frame section window definer 405 can be configured to define a series of second half section analysis windows such that they are aligned starting at the beginning of the second half section 1003 such as shown in FIG. 11.

Furthermore the analysis window definer 301 can further comprise in some embodiments a first half frame section window definer 407 configured to receive input from the section information and also in some embodiments information from the second half frame section window definer 405. Thus, for example as shown in FIG. 11, on receiving information on the second half frame section analysis windows from the second half frame section window definer 405 (that a window frame position has been determined for the second half section analysis windows 1111 and 1113 as shown in FIG. 11), the first half frame section window definer 407 can be configured to define section analysis windows starting at the beginning of the first half section such as also shown in FIG. 11.

The look-ahead section window information can in some embodiments be passed to a window multiplexer 409.

In some embodiments the analysis window definer 301 can comprise a window multiplexer 409 configured to receive the section window definitions and forward the section window definitions to the analysis window analyzer and modifier 303.

The definition of analysis windows with positions starting at the beginning of the half section and look-ahead section is shown in FIG. 9 by step 605 following the determination that the look-ahead section length is sufficient.

The look-ahead section window definer 403 can on receiving an indicator from the look-ahead section analyzer 401 that the look-ahead section length is insufficient further be configured to determine whether or not an analysis window for the look-ahead section is to be defined. In some embodiments the look-ahead section analyzer 401 can furthermore carry out this determination. For example, look-ahead section analyzer 401 could in some embodiments determine whether the look-ahead section length is close to or equal to 0 and indicate therefore that there is too little data to analyser. When the look-ahead section analyzer 401 or in some embodiments the look-ahead section window definer 403 determines that no analysis window for the look-ahead section is to be defined then the look-ahead section window definer 403 can be configured to pass an indicator to the second half frame section window definer 405 and/or to the first half frame section window definer 407 that no look-ahead section windows are to be defined. In some embodiments the look-ahead section window definer 403 can be configured to pass an indicator to the window multiplexer 409 indicating that no look-ahead section analysis windows have been defined such that as described herein, during the pitch estimation selection or tracking operation a previous frame pitch estimate can be used in order to increase the length of the overall signal segment used in pitch tracking.

The definition of windows only for the first and second half frame sections are shown in FIG. 9 as step 611 following the answer “no” to the decision step 607 of whether to define analysis windows for the look-ahead section.

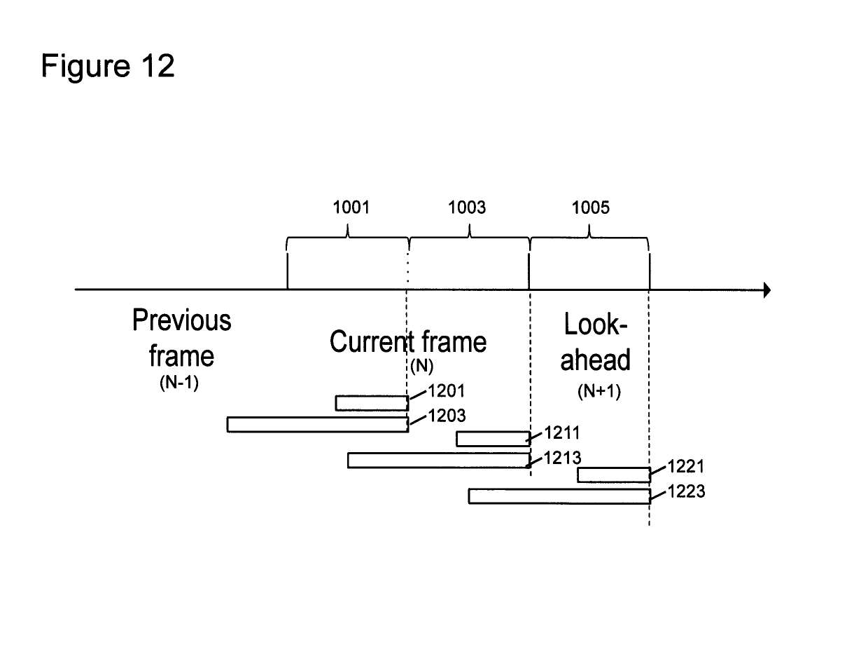

In some embodiments the look-ahead section window definer 403 can be configured when the look-ahead section length is insufficient (for window analysis positions to start at the beginning of each half frame section) and the look-ahead section is sufficiently long to allow a window to define the analysis window position to finish or be aligned with the end of the look-ahead section analysis windows to the end of the look-ahead section. This can be seen for example in FIG. 12 where the window example shows the look-ahead section 1005 having a defined short look-ahead window 1221 which is aligned with the end of the look-ahead section and the start of the short look-ahead window 1221 defined by the length of the short look-ahead window. Similarly a long look-ahead window 1223 is shown aligned at the end of the look-ahead section. Thus in such embodiments the length of the longer look-ahead window or windows does not have to be compromised and shortened due to a lack of data. The look-ahead section window definer 403 can in some embodiments pass an indicator or information to the second half frame section window definer 405 and the first half frame section window definer 407 indicating the location or position of the look-ahead windows to assist in the definition of the second half frame windows and/or the first half frame windows.

The operation of shifting or aligning the look-ahead section analysis windows to the end of section is shown in FIG. 9 by step 609.

In some embodiments the look-ahead section window definer 403 can be configured to position the windows relative to each other such that they are not all aligned at either the end or the beginning of the look-ahead frame. For example in some embodiments the look-ahead section analyzer determines whether or not the coverage of the look-ahead section is sufficiently defined by the look-ahead analysis windows. Thus for example in some embodiments where the look-ahead section is sufficiently large, the look-ahead section window definer 403 can be configured to define multiple window start or end points. In other words in some embodiments the look-ahead section can be further divided into sub-sections each sub-section being configured to have a set of analysis windows.

In some embodiments the second half frame section window definer 403 and the first half frame section window definer 407, on receiving an indication or information that the look-ahead section window definer has defined the look-ahead section windows such that they are aligned at the end of the look-ahead section, can be configured to define their respective analysis windows such that they are also aligned at the end of their respective half frames. This for example is shown with respect to FIG. 12 wherein the second half frame section window definer 405 is shown having defined the short analysis window 1211 for the second half frame ending or aligned at the end of the second half frame section and the long second half frame analysis window also ending or aligned at the end of the second half frame section 1003. Similarly the first half frame section window definer 407 is configured as shown in FIG. 12 in some embodiments to end the analysis windows such that the short analysis window for the first half frame section 1001 is aligned at the end of the first half frame section 1001, and the long analysis window for the first half frame is also aligned such that it ends at the end of the first half frame section.

It is shown for example in FIG. 12 that the long window analysis can thus extend beyond the beginning of the first half frame section and thus can in some embodiments require the autocorrelator to use data from the previous frame. However it would be understood that the use of data from the previous would not incur any delay penalty.

In some embodiments the second half frame section window definer 405 and/or the first half frame section window definer 407 can be configured to perform a check to determine whether or not the defined windows provide a “sufficient” coverage of the first and second half frames. This can for example be determined by comparing the overlap between the defined look-ahead analysis windows and the defined second half frame analysis windows. Where the overlap between the two sets of windows is sufficiently large (for example greater than a defined overlap threshold) the second half frame section window definer 405 can be configured to shift or move the alignment of the second half frame windows such that the overlap between the second half frame windows and the look-ahead windows is reduced.

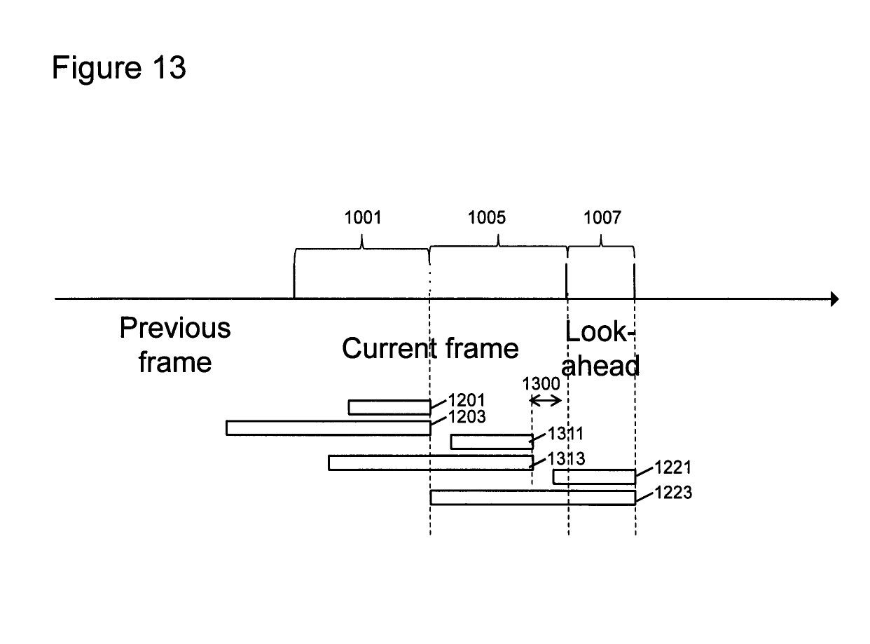

This for example is shown in FIG. 13 where a look-ahead section length is reduced such that even the short analysis window for the look-ahead section aligned with the end of the look-ahead section overlaps with the end of the second half frame of the current frame. Furthermore the long look-ahead analysis window 1223 almost covers the whole of the second half of the frame 1005 as well as the look-ahead section 1007. Thus in such an embodiment the second half frame section window definer 405 can be configured to shift or align at least one of (and as shown in FIG. 13 all of) the second half frame analysis windows by a determined amount 1300 such that the second half frame section analysis windows, such as shown in FIG. 13 by the short analysis window 1311 and the long analysis window 1313, are aligned relative to the shift distance 1300 from the end of the second half frame end.

The operations of detecting whether or determining whether or not the coverage is sufficient for the first and second half frames with the analysis at the end of sections is shown in FIG. 9 by step 613. In some embodiments the first half frame section window definer can perform similar checks to determine whether the coverage of the first half frame is sufficient relative to the second half frame section and look-ahead section. In such embodiments for example the overlap between first half frame analysis windows and second half frame analysis windows is determined and compared against a further overlap threshold value. When the overlap is greater than this threshold value then the first half frame section defines can align the first half frame analysis windows relative to the end of the first half frame shifted forward by a first half frame offset.

The operation of shifting the first and/or second half frames with analysis windows is shown in FIG. 9 by step 617.

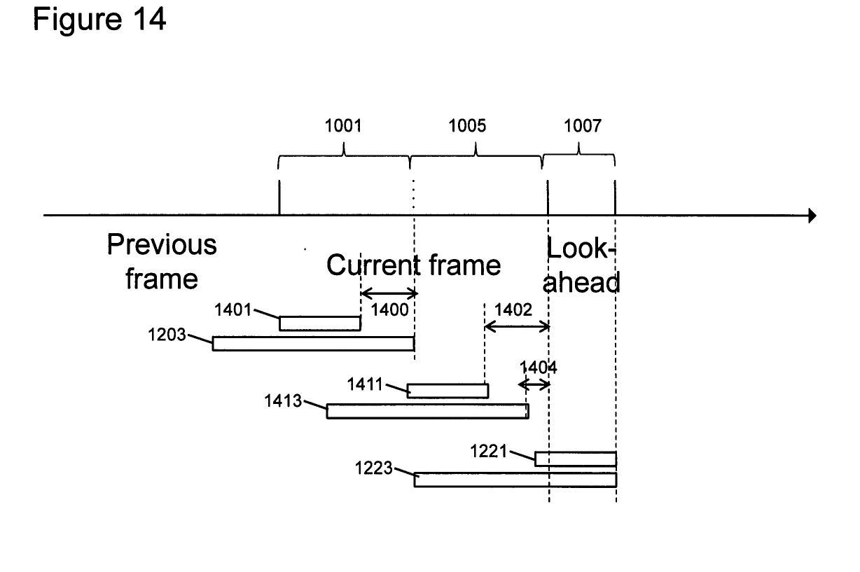

A further example of the shifting operation is shown in FIG. 14 wherein the analysis of the analysis windows coverage is such that not only are the second half windows shifted relative to the end of the second half frame but they are shifted relative to each other such that the short and long second half frame analysis windows are not aligned with each other. As shown in FIG. 14 the second half frame shows a short window 1411 offset by a first second half frame offset 1402 from the end of the second half frame end and the long window 1413 shifted by a second half frame offset 1404 from the end of the second half frame. Furthermore the example shown in FIG. 14 shows a shifting of the first half frame windows wherein the short analysis window 1401 is shifted by a first half frame offset 1400 from the end of the first half frame.

As the aim of pitch estimation is to provide pitch estimates for the current frame, (and as such two pitch estimates for each half of the current frame) the definition of the analysis windows should be chosen in some embodiments such that the defined windows represent the respective half frames and not only covering as much data as possible. Thus in some embodiments the alignment of the analysis window can be determined by inputs other than minimising or reducing the analysis window overlap. Thus for example a signal characteristic can be further used as an input for offsetting and defining analysis window position.

In some embodiments, the analysis windows may therefore be aligned, given that the length of available look-ahead allows it, such that the short analysis windows are aligned to the start points of their respective half frames (or look-ahead) while the long analysis windows are aligned to the end points of the half frames (or look-ahead).

Where the second half frame section window definer 405 and the first half frame section window definer 407 determine that the coverage is sufficient for the first and second half frames where the analysis windows are aligned at the end of the respective sections then the defined windows are retained.

The operation of retaining the output windows is shown in FIG. 9 by step 615.

In some embodiments the analysis window generator 203 can further comprise an analysis window analyzer and modifier 303. The analysis window analyzer and modifier can in some embodiments receive the analysis windows defined by the analysis window definer 301 and perform a further series of checks and modifications to the windows to improve the coverage and stability of the pitch estimation process.

For example in some embodiments on receiving the analysis windows from the analysis window definer 301, the analysis window analyzer and modifier 303 can be configured to perform a complexity check to determine whether or not the processing requirement formed by the potential analysis of the windows defined is greater than the processing capacity or the time within which the pitch estimation has to be performed.

The complexity check operation is shown in FIG. 8 by step 553.

Where the complexity check determines that the processing capacity is greater than the requirement (or in other words that the analysis can be performed in sufficient time) then the analysis window analyzer and modifier 303 outputs the window definitions to the autocorrelator or a buffer associated with the autocorrelator 205 for processing.

The operation of outputting the window definitions as they are originally defined and without modification is shown in FIG. 8 by step 557.

Where the analysis window analyzer and modifier 303 determines that the processing requirement is greater than the processing capacity, in other words there is insufficient time to perform all of the operations required within the defined time period by which an estimate is to be performed then the analysis window analyzer and modifier can be configured to remove windows to reduce the computational complexity.

For example in some embodiments the analysis window analyzer and modifier 303 can be configured to remove the longest window in the second half frame to reduce the analysis period. This is possible without causing significant stability problems for the pitch estimate as the analysis window analyzer and modifier can in some embodiments insert an indicator or provide information to the estimate selector and/or autocorrelator such that autocorrelator or estimate selector tracking operation replaces the missing estimate by a contextually closest half frame estimate. For example the second half frame long window estimate can be replaced by the look-ahead estimate for the long frame and vice versa in some embodiments.

The operation of removing a window to reduce the complexity is shown in FIG. 8 by step 555.

In other words in at least one embodiment as described herein the means for defining the at least one analysis window may comprise means for defining the analysis window dependent on at least one of: a position of the audio signal portion; a size of the audio signal portion; a size of neighbouring audio signal portions; a defined neighbouring audio signal portion analysis window; and at least one characteristic of the first audio signal. Furthermore the first audio signal characteristic may similarly be at least one of: voiced audio; unvoiced audio; voiced onset audio; voiced offset audio or defined structure of the first audio signal.

Similarly the means for determining the at least one analysis window may be as discussed herein be dependent on the processing capacity of the pitch estimator and/or apparatus.

The windows to be analyzed can then be passed to the autocorrelator 205.

The autocorrelator can be configured to generate autocorrelation values for the length of the window for all suitable values in the pitch range as defined for each window. The correlation function computation can be carried out according to any suitable correlation method. For example a correlation function computation can be carried out using the correlation function computation as provided in the G.718 standard using the windows as defined by the analysis window generator 203. The output of the autocorrelator can be passed to the estimate selector 207.

The generation of correlation values for each window and in each section is shown in FIG. 7 by step 505.

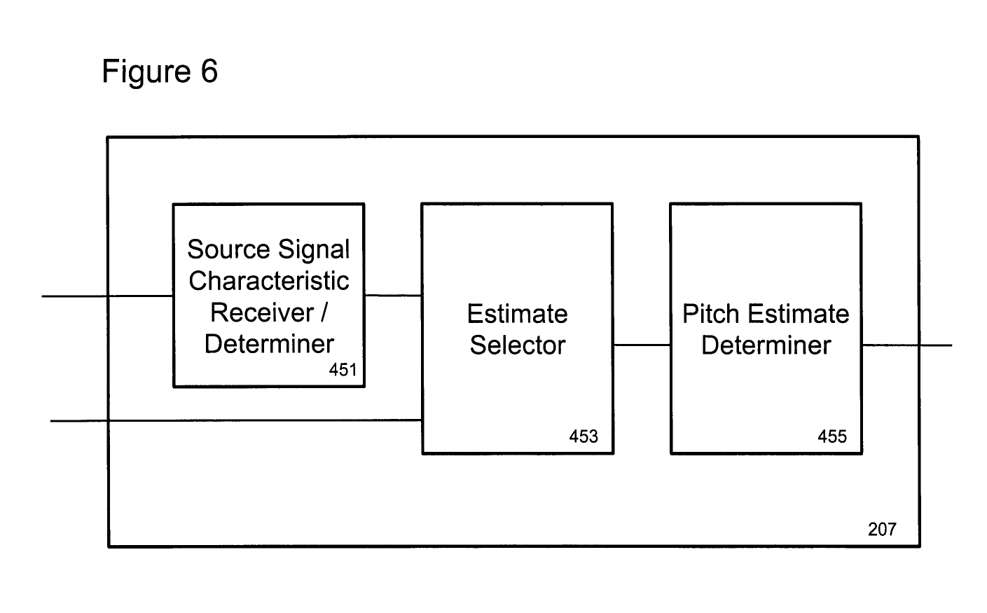

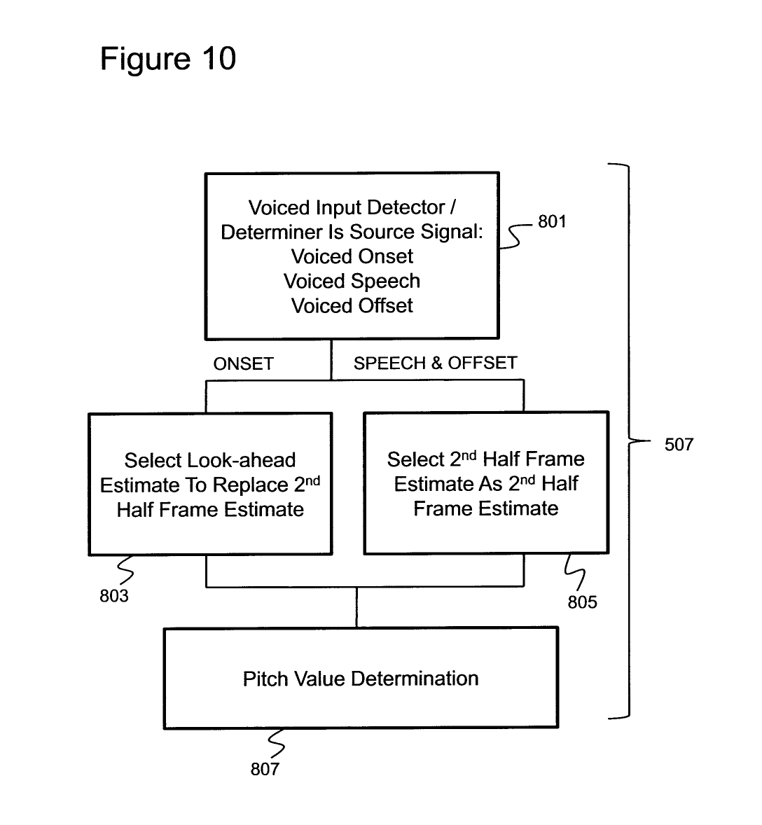

In some embodiments the pitch estimator 151 comprises an estimate selector 207. The estimate selector can be configured to perform the operations of generating an open-loop pitch estimate from the correlation values provided by the correlators 205. The estimate selector 207 can be shown in further detail with respect to FIG. 6, the operations of which are shown schematically in FIG. 10.

In some embodiments the estimate selector 207 can be configured to comprise a source signal characteristic receiver or determiner 451, the source signal characteristic receiver or determiner 451 can be configured to either receive or determine a source signal characteristic. An example of a source signal characteristic is the determination of whether the source signal for the current frame is a voiced onset, voiced speech or voiced offset frame.

The operation of determining or detecting the source signal characteristic in terms of voiced onset, voiced speech or voice offset is shown in FIG. 10 by step 801.

The source signal characteristic generated by the source signal characteristic receiver or determiner 451 can be passed to the estimate selector 453. The estimate selector 453 can be configured to receive the estimates from the autocorrelator 205 with respect to the various analysis windows. The estimate selector 453 can then dependent on the output of the source signal characteristic receiver or determiner 451 modify the correlation result estimates dependent on the source signal characteristic value. Thus for example in some embodiments the estimate selector 453 can on determining that the source signal characteristic receiver/determiner 451 has output a voiced onset indicator select the look-ahead estimator value to replace the second half frame estimate for the correlation estimates.

The operation of selecting the look-ahead estimates to replace the second half frame estimates is shown in FIG. 10 by step 803.

Otherwise in some embodiments the estimate selector 453 can be configured to select the second half frame estimates and output the second half frame estimates as they are without modification or change.

The operation of outputting the second half frame estimates then modified is shown in FIG. 10 by step 805.

The estimates can then be output by the estimate selector 453 to the pitch estimate determiner 455.

In some embodiments the modification of the pitch track is performed after the pitch estimate determiner 455.

The pitch estimate determiner 455 can perform any suitable pitch estimate determination operation. For example the pitch estimate determiner can perform pitch estimate determinations using the G.718 standard definitions. However any suitable estimate selection approach could be implemented.

In some embodiments the source signal characteristic generated by the source signal characteristic receiver or determiner 451 can be used in the pitch estimate determiner 455. For example the pitch estimate determiner can use the source signal characteristic to modify pitch estimate reinforcement thresholds applied in the pitch estimate determination such as described in the G.718 standard. In particular the reinforcing of the neighbouring pitch estimate values between the first half frame and the second half frame as well as between the second half frame and the look-ahead can be modified according to the source signal characteristic. For example the pitch estimate of the second half frame can be reinforced more strongly when it is similar to the look-ahead pitch estimate in a frame in which the source signal exhibits a voicing onset.

The pitch value determination is shown in FIG. 10 by step 807.

In such embodiments by using the source signal characteristic, a more stable and representative pitch track can be selected by choosing the estimates which benefit from having voicing in the frame. Thus, typically it would be better to select the look-ahead estimate instead of the nominal second half frame estimate for the second half frame during a voiced onset whereas during voiced speech and voicing offsets it is generally preferable to select the second half frame estimate over the look-ahead estimate. It would be understood that in some embodiments during voiced onsets the algorithm can favour those pitch estimate values of the second half frame that are similar to the pitch estimate values in the look-ahead by reinforcing them more strongly than during voiced speech, a voicing offset, or unvoiced speech.

In some embodiments the current frame and available look-ahead can be divided into more segments than two half frames and look-ahead. In these embodiments the pitch track modification or the modification of the reinforcing functions can be performed in the last current frame segment and the look-ahead or in any other suitable configuration. In some embodiments the modification of the reinforcing functions may be determined continuously for the whole current frame.

In other words in some embodiments any means for determining the at least one characteristic of the audio signal over at least two portions of the audio signal can be configured to determine a voiced onset audio signal, and may then control the means for determining the first pitch estimate to reinforce the pitch estimate value in a second portion of the audio signal over the pitch estimate value in a first portion of the audio signal preceding the second portion of the audio signal. Similarly in some embodiments the determination of a voiced and/or voiced offset audio signal may cause the means for determining at least one characteristic to control the means for determining the first pitch estimate to perform reinforcing the pitch estimate value in the first portion of the audio signal over the pitch estimate value in a second portion of the audio signal succeeding the first portion of the audio signal. Furthermore in some embodiments the determination of an unvoiced speech or no-speech audio signal may control the means for determining the first pitch estimate to perform modifying a reinforcing function to be applied to the pitch estimation value.

In some embodiments the source signal characteristic receiver 451 can receive a flag or other indicator indicating whether or not the current frame is voiced or voiced onset or offset or unvoiced.

In some embodiments the modification of the pitch track or the modification of the reinforcing functions can be performed after each unvoiced speech or no-speech frame in order to approximate detection of voicing onset.

The determination of the pitch lag or pitch estimation for each section and thus the pitch track is shown in FIG. 7 by step 507.

Although the above examples describe embodiments of the application operating within a codec within an apparatus 10, it would be appreciated that the invention as described below may be implemented as part of any audio (or speech) codec, including any variable rate/adaptive rate audio (or speech) codec. Thus, for example, embodiments of the application may be implemented in an audio codec which may implement audio coding over fixed or wired communication paths.

Thus user equipment may comprise an audio codec such as those described in embodiments of the application above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the application may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the application may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Thus at least some embodiments the encoder may be an apparatus comprising at least one processor and at least one memory including computer program code for one or more programs, the at least one memory and the computer program code configured to, with the at least one processor, cause the apparatus at least to perform: defining at least one analysis window for a first audio signal, wherein the at least one analysis window is dependent on the first audio signal; and determining a first pitch estimate for the first audio signal, wherein the first pitch estimate is dependent on the first audio signal sample values within the analysis window.

The embodiments of this application may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

Thus at least some embodiments of the encoder may be a computer-readable medium encoded with instructions that, when executed by a computer perform: defining at least one analysis window for a first audio signal, wherein the at least one analysis window is dependent on the first audio signal; and determining a first pitch estimate for the first audio signal, wherein the first pitch estimate is dependent on the first audio signal sample values within the analysis window.

Furthermore at least some of the embodiments of the decoder may be provided a computer-readable medium encoded with instructions that, when executed by a computer perform: defining at least one analysis window for a first audio signal, wherein the at least one analysis window is dependent on the first audio signal; and determining a first pitch estimate for the first audio signal, wherein the first pitch estimate is dependent on the first audio signal sample values within the analysis window.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the application may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term ‘circuitry’ refers to all of the following:
(a) hardware-only circuit implementations (such as implementations in only analog and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-55. (canceled)

56. A method comprising:
dividing a first audio signal into at least two portions;
defining the at least one analysis window for the first audio signal dependent on, a position of the audio signal portion, a size of the audio signal portion, a size of neighbouring audio signal portions, a defined neighbouring audio signal portion analysis window, and at least one characteristic of the first audio signal;
determining a first pitch estimate for the first audio signal, wherein the first pitch estimate is dependent on the first audio signal sample values within the analysis window.

57. The method as claimed in claim 56, wherein defining the at least one analysis window comprises defining at least one of:
number of analysis windows;
position of analysis window for each analysis window with respect to the first audio signal; and
length of each analysis window.

58. The method as claimed in claim 56, wherein the at least two portions comprise:
a first half frame portion;
a second half frame portion succeeding the first half frame; and
a look ahead frame portion succeeding the second half frame.

59. The method as claimed in claim 56, further comprising determining at least one characteristic of the first audio signal, wherein the first audio signal characteristic comprises at least one of:
voiced audio;
unvoiced audio;
voiced onset audio; and
voiced offset audio.

60. The method as claimed in claim 56, wherein defining at least one analysis window for a first audio signal is dependent on a defined structure of the first audio signal and performed prior to receiving the first audio signal sample values.

61. The method as claimed in claim 56, wherein defining the at least one analysis window comprises:
defining at least one window in at least one of the portions; and
defining at least one further window in at least one further portion dependent on the at least one window.

62. The method as claimed in claim 56, wherein the determination of the at least one analysis window is further dependent on the processing capacity of the pitch estimator.

63. The method as claimed in claim 56, wherein determining the first pitch estimate for the first audio signal comprises determining an autocorrelation value for each analysis window.

64. The method as claimed in claim 63, wherein determining the first pitch estimate comprises tracking the autocorrelation values for each analysis window over the length of the first audio signal.

65. The method as claimed in claim 56, wherein determining the first pitch estimate is dependent on at least one characteristic of the first audio signal.

66. The method as claimed in claim 65, wherein the at least one characteristic of the audio signal comprises determining the at least one audio signal is over at least two portions of the audio signal is a:
voiced onset audio signal then wherein determining the first pitch estimate comprises reinforcing the pitch estimate value in a second portion of the audio signal over the pitch estimate value in a first portion of the audio signal preceding the second portion of the audio signal;
voiced and/or voiced offset audio signal then determining the first pitch estimate comprises reinforcing the pitch estimate value in the first portion of the audio signal over the pitch estimate value in a second portion of the audio signal succeeding the first portion of the audio signal; and
unvoiced speech or no-speech then modifying a reinforcing function to be applied to the pitch estimation value.

67. An apparatus comprising at least one processor and at least one memory including computer program code for one or more programs, the at least one memory and the computer program code configured to, with the at least one processor, cause the apparatus at least to:
divide a first audio signal into at least two portions;
define the at least one analysis window for the first audio signal dependent on, a position of the audio signal portion, a size of the audio signal portion, a size of neighbouring audio signal portions, a defined neighbouring audio signal portion analysis window, and at least one characteristic of the first audio signal;
determine a first pitch estimate for the first audio signal, wherein the first pitch estimate is dependent on the first audio signal sample values within the analysis window.

68. The apparatus as claimed in claim 67, wherein defining the at least one analysis window further causes the apparatus to further define at least one of:
number of analysis windows;
position of analysis window for each analysis window with respect to the first audio signal; and
length of each analysis window.

69. The apparatus as claimed in claim 67, wherein the at least two portions comprise:
a first half frame portion;
a second half frame portion succeeding the first half frame; and
a look ahead frame portion succeeding the second half frame.

70. The apparatus as claimed in claim 67, further caused to determine at least one characteristic of the first audio signal, wherein the first audio signal characteristic comprises at least one of:
voiced audio;
unvoiced audio;
voiced onset audio; and
voiced offset audio.

71. The apparatus as claimed in claim 67, wherein the apparatus caused to define at least one analysis window for a first audio signal is dependent on a defined structure of the first audio signal and performed prior to receiving the first audio signal sample values.

72. The apparatus as claimed in claim 67, wherein the apparatus caused to define the at least one analysis window further causes the apparatus to:
define at least one window in at least one of the portions; and
define at least one further window in at least one further portion dependent on the at least one window.

73. The apparatus as claimed in claim 67, wherein the determination of the at least one analysis window is further dependent on the processing capacity of the pitch estimator.

74. The apparatus as claimed in claim 67, wherein the apparatus caused to determine the first pitch estimate for the first audio signal further causes the apparatus to determine an autocorrelation value for each analysis window.

75. The apparatus as claimed in claim 74, wherein the apparatus caused to determine the first pitch estimate further causes the apparatus to track the autocorrelation values for each analysis window over the length of the first audio signal.

76. The apparatus as claimed in claim 67, wherein the apparatus caused to determine the first pitch estimate is dependent on at least one characteristic of the first audio signal.

77. The apparatus as claimed in claim 76, further caused to determine the at least one characteristic of the audio signal over at least two portions of the audio signal and wherein the at least one characteristic of the audio signal is determined as:
a voiced onset audio signal, the apparatus caused to determine the first pitch estimate is further caused to reinforce the pitch estimate value in a second portion of the audio signal over the pitch estimate value in a first portion of the audio signal preceding the second portion of the audio signal;
a voiced and/or voiced offset audio signal, the apparatus caused to determine the first pitch estimate is further caused to reinforce the pitch estimate value in the first portion of the audio signal over the pitch estimate value in a second portion of the audio signal succeeding the first portion of the audio signal; and
an unvoiced speech or no-speech audio signal, the apparatus caused to determine the first pitch estimate is further caused to modify a reinforcing function to be applied to the pitch estimation value.
